(19) United States
(12) Patent Application Publication
(10) Pub. No.: US 2005/0200724 A1
(43) Pub. Date: Sep. 15, 2005

(54) Using a separate color sensor for white balance calculation

(76) Inventors: Seela Raj D Rajaiah, Penang (MY); Khin Mien Chong, Penang (MY)

Correspondence Address: AGILENT TECHNOLOGIES, INC.;Legal Department, DL 429, Intellectual Property Administration, P.O. Box 7599, Loveland, CO, 80537-0599, US

(21) Appl. No.: 10/797,308

(22) Filed: Mar. 10, 2004

(51) Int. Cl. H04N 9/73

(52) U.S. Cl. 348/223.1

(57) ABSTRACT

An image is captured using a color filter array. A plurality of color components of light incident upon a color sensor are detected. An average intensity value for each of the plurality of color components is generated. The average intensity values for the plurality of color components are used to calculate a white balance for the image captured by the color filter array.

### BACKGROUND

The present invention relates to capturing an image and pertains particularly to using a separate color sensor for white balance calculation.

An important step in processing digital images captured by a digital camera is the estimation of the White Point. The White Point is the illumination that occurs at the brightest part of the image and is represented as white in the final image. The White Point is determined after an image has been captured and is applied to algorithms so that white balance can be performed. White balancing is part of a scheme of corrections and improvements for image enhancement so that the final image is closer to what the eye sees.

White balancing is a correction used to adjust for illuminant so that white background will look white or close to white in the image. White balance is performed automatically by the human eye. In digital cameras, white balance can be attained by adjusting the gain of the red, green and blue (RGB) channels.

There are many ways cameras use to calculate white balance. Typically white balance is performed using information extracted from within the captured image. Alternatively, one or more grayscale optical sensors can be used to provide additional information for the white balance calculation. See, for example U.S. Pat. No. 6,215,962 and U.S. Pat. No. 6,441,903. However, all existing methods require significant processing time, which can slow the operation of a camera.

### SUMMARY OF THE INVENTION

In accordance with an embodiment of the present invention, an image is captured using a color filter array. A plurality of color components of light incident upon a color sensor is detected. An average intensity value for each of the plurality of color components is generated. The average intensity values for the plurality of color components are used to calculate a white balance for the image captured by the color filter array.

### BRIEF DESCRIPTION OF THE DRAWINGS

FIG. 1 is simplified front view of a camera that includes a color sensor used for detecting White Balance in accordance with an embodiment of the present invention.

FIG. 2 is simplified block diagram of a color sensor used for determining white balance in accordance with an embodiment of the present invention.

FIG. 3 is simplified block diagram illustrating processing of an image utilizing a separate color sensor for determining white balance in accordance with an embodiment of the present invention.

### DESCRIPTION OF THE EMBODIMENT

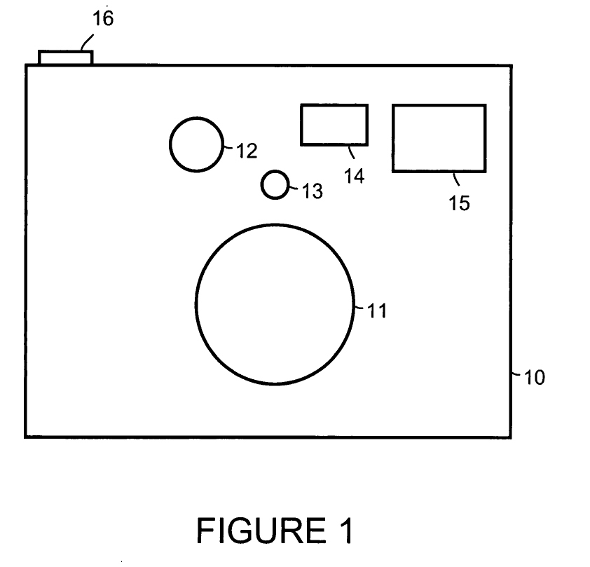

FIG. 1 is simplified front view of a camera 10. Camera 10 includes a color filter array 11 located behind the camera optics. Color filter array 11 includes sensors that capture images for processing by camera 10. A separate color sensor 13 is used to provide a parallel processing path to calculate white balance. Camera 10 includes other components such as a viewfinder 14, a flash 15 and a shutter button 16.

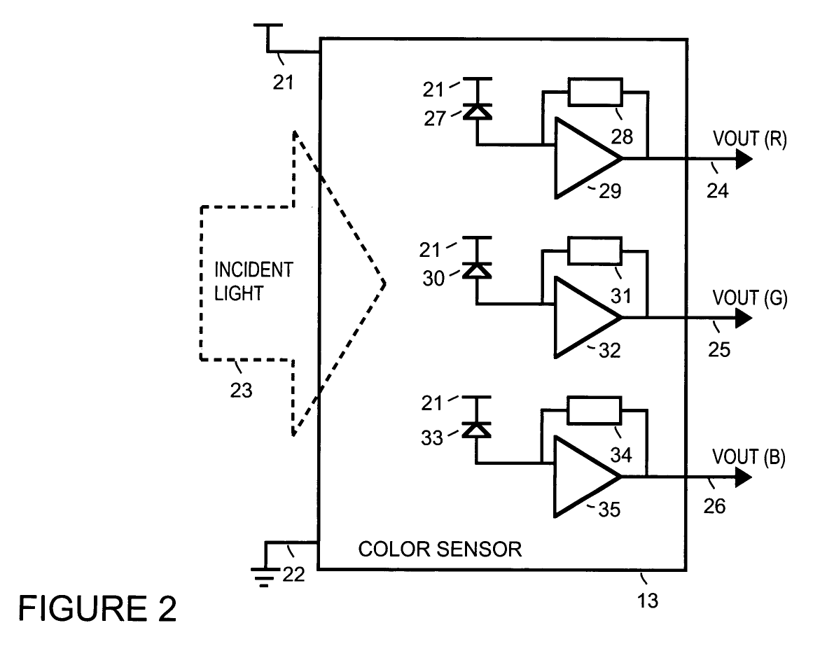

FIG. 2 is simplified block diagram of color sensor 13. Color sensor 13 receives a power input signal 21 and a ground input signal 22. For example power input 21 is at 5.0 volts. For example, color sensor 13 has a spectral measurement of wavelength from 400 nanometers (nm) to 700 nm.

In response to incident light 23, color sensor 13 generates three separate output voltages (Vout): a Vout (R) signal 24, a Vout (G) signal 25 and a Vout (B) signal 26. Vout (R) signal 24 is an analog signal that indicates the proportional red component of incident light 23 upon color sensor 13. For example, Vout (R) signal 24 is a DC voltage between 0 and 3 volts. Vout (G) signal 25 is an analog signal that indicates the proportional green component of incident light 23 upon color sensor 13. For example, Vout (G) signal 25 is a DC voltage between 0 and 3 volts. Vout (B) signal 26 is an analog signal that indicates the proportional blue component of incident light 23 upon color sensor 13. For example, Vout (B) signal 26 is a DC voltage between 0 and 3 volts.

Vout (R) signal 24 is generated by a photo sensor 27, an amplifier 29 and a feedback resistor 28, which are all located within color sensor 13. Photo sensor 27 includes an integrated color filter in red. Photo sensor 27 is connected to power input signal 21.

Vout (G) signal 25 is generated by a photo sensor 30, an amplifier 32 and a feedback resistor 31, which are all located within color sensor 13. Photo sensor 30 includes an integrated color filter in green. Photo sensor 30 is connected to power input signal 21.

Vout (B) signal 26 is generated by a photo sensor 33, an amplifier 35 and a feedback resistor 34, which are all located within color sensor 13. Photo sensor 33 includes an integrated color filter in blue. Photo sensor 33 is connected to power input signal 21.

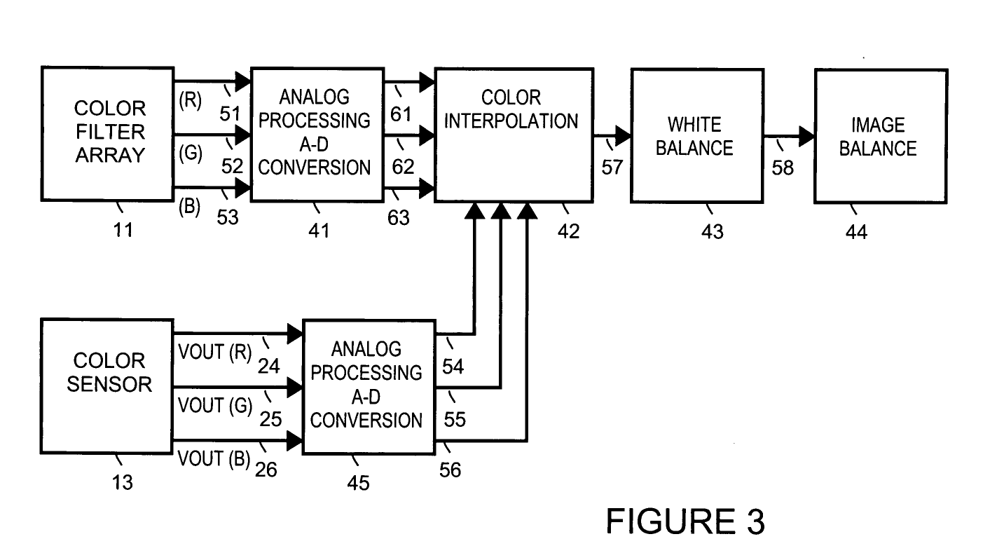

FIG. 3 is simplified block diagram illustrating processing of an image within camera 10. Color filter array produces a red (R), green (G) and blue (B) value for each captured pixel of the image. The RGB values are forwarded to analog processing and analog to digital (A-D) conversion block 41 via a signal path 51, a signal path 52 and a signal path 53. Analog processing and A-D conversion block 41 generates digital RGB values for each pixel. The RGB values are forwarded to color interpolation block 42 via a signal path 61, a signal path 62 and a signal path 63. Color interpolation block 42 performs color interpolation and sends the resulting image to white balance block 43 via a signal path 57. White balance block 43 performs white balance and sends the resulting image to an image balance block 44 via a signal path 58. Other image processing blocks also may be present within camera 10, as will be understood by persons of ordinary skill in the art.

Color filter array 11, analog processing A-D conversion block 41, white balance block 43 and image balance block 44 are conventional processing blocks within conventional digital cameras. Color interpretation block 42 could be implemented to process the captured digital image to generate an average red intensity (Ravg), an average green intensity (Gavg) and an average blue intensity (Bavg) for the captured image, used in the calculation of White Balance. The present invention obviates the necessity of generating Ravg, Gavg and Bavg by color interpretation block 42. Instead, Ravg, Gavg and Bavg are generated in a parallel path based on information captured by color sensor 13.

Color sensor 13 generates Vout (R) signal 24, Vout (G) signal 25 and Vout (B) signal 26. Analog processing A-D conversion block 45 receives Vout (R) signal 24, Vout (G) signal 25 and Vout (B) signal 26 and produces an Ravg signal 54, a Gavg signal 55 and a Bavg signal 56. For example, Ravg signal 54, Gavg signal 55 and Bavg signal 56, are each eight bit digital signals transmitted serially to color interpolation block 42. The eight bits of Ravg signal 54 are an Ravg value that is a digital representation of the analog value of Vout (R) signal 24. The eight bits of Gavg signal 55 are a Gavg value that is a digital representation of the analog value of Vout (G) signal 25. The eight bits of Bavg signal 56 are a Bavg value that is a digital representation of the analog value of Vout (B) signal 26.

Color interpolation block 42 forwards the Ravg, Gavg and Bavg values from analog processing A-D conversion block 45 on to white balance block 43. This saves color interpolation block 42 the processing time required to generate Ravg, Gavg and Bavg values from the image captured by color filter array 11.

The foregoing discussion discloses and describes merely exemplary methods and embodiments of the present invention. As will be understood by those familiar with the art, the invention may be embodied in other specific forms without departing from the spirit or essential characteristics thereof. Accordingly, the disclosure of the present invention is intended to be illustrative, but not limiting, of the scope of the invention, which is set forth in the following claims.

1. A method comprising the following:
capturing an image using a color filter array;
detecting a plurality of color components of light incident upon a color sensor;
generating an average intensity value for each of the plurality of color components; and,
using the average intensity values for the plurality of color components to calculate a white balance for the image captured by the color filter array.

2. A method as in claim 1:
wherein each of the plurality of color components is an analog value; and,
wherein each of the average intensity values is a digital value.

3. A method as in claim 1 wherein the method is performed by a digital camera.

4. A method as in claim 1 wherein the plurality of color components include a red component, a green component and a blue component.

5. A method as in claim 1:
wherein the plurality of color components include a red component, a green component and a blue component; and,
wherein the average intensity values include an average red intensity value derived from the red component, an average green intensity value derived from the green component and an average blue intensity value derived from the blue component.

6. A method as in claim 5:
wherein the red component, the green component and the blue component are analog values; and,
wherein the average red intensity value, the average green intensity value and the average blue intensity value are digital values.

7. A method as in claim 1 wherein capturing the image and detecting the plurality of color components are performed simultaneously allowing for parallel processing.

8. A device that takes an image, comprising:
a color filter array that captures an image;
a color sensor that detects a plurality of color components of incident light;
a converter that generates an average intensity value for each of the plurality of color components; and,
white balance calculator that uses the average intensity values for the plurality of color components to calculate a white balance for the image captured by the color filter array.

9. A device as in claim 8:
wherein each of the plurality of color components is an analog value; and,
wherein each of the average intensity values is a digital value.

10. A device as in claim 8 wherein the device is a digital camera.

11. A device as in claim 8 wherein the plurality of color components include a red component, a green component and a blue component.

12. A device as in claim 8:
wherein the plurality of color components include a red component, a green component and a blue component; and,
wherein the average intensity values include an average red intensity value derived from the red component, an average green intensity value derived from the green component and an average blue intensity value derived from the blue component.

13. A device as in claim 12:
wherein the red component, the green component and the blue component are analog values; and,
wherein the average red intensity value, the average green intensity value and the average blue intensity value are digital values.

14. A device as in claim 8 wherein the color sensor includes, for each color component, a photo sensor with an integrated filter.

15. A device that takes an image, comprising:
color filter array means for capturing an image;
color sensor means for detecting a plurality of color components of incident light;
converter means for generating an average intensity value for each of the plurality of color components; and,
white balance means for using the average intensity values for the plurality of color components to calculate a white balance for the image captured by the color filter array.

16. A device as in claim 15:
wherein each of the plurality of color components is an analog value; and,
wherein each of the average intensity values is a digital value.

17. A device as in claim 15 wherein the device is a digital camera.

18. A device as in claim 15 wherein the plurality of color components include a red component, a green component and a blue component.

19. A device as in claim 15:
wherein the plurality of color components include a red component, a green component and a blue component; and,
wherein the average intensity values include an average red intensity value derived from the red component, an average green intensity value derived from the green component and an average blue intensity value derived from the blue component.

20. A device as in claim 18:
wherein the red component, the green component and the blue component are analog values; and,
wherein the average red intensity value, the average green intensity value and the average blue intensity value are digital values.
